(19) United States
(12) Patent Application Publication
(10) Pub. No.: US 2007/0139427 A1
(43) Pub. Date: Jun. 21, 2007

(54) Information processing apparatus and operation speed control method

(75) Inventor: Masaya Sahashi, Ome-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/603,207

(22) Filed: Nov. 22, 2006

(30) Foreign Application Priority Data
Dec. 16, 2005 (JP) 2005-363405

(51) Int. Cl. G09G 5/37

(52) U.S. Cl. 345/561

(57) ABSTRACT

According to one embodiment, an information processing apparatus includes a processor, a display controller which executes a graphics arithmetic process of drawing frames in a video memory in accordance with a drawing request from the processor, and executes a screen refresh process of updating a display screen of a display device by using the frames drawn in the video memory in accordance with a refresh rate which designates a number of frames to be output to the display device per unit time, a calculation unit which calculates, based on content of the drawing request, a maximum number of frames which are drawable by the display controller per unit time, and a control unit which executes an operation speed control process of decreasing an operation speed of the display controller, if the calculated maximum number of frames is greater than the number of frames designated by the refresh rate.

### CROSS-REFERENCE TO RELATED APPLICATIONS

This application is based upon and claims the benefit of priority from Japanese Patent Application No. 2005-363405, filed Dec. 16, 2005, the entire contents of which are incorporated herein by reference.

### BACKGROUND

1. Field

One embodiment of the invention relates to an information processing apparatus such as a personal computer, and an operation speed control method for controlling the operation speed of a display controller which is provided in the apparatus.

2. Description of the Related Art

In recent years, various types of personal computers, which can display motion video data and 3D graphics data, have been developed.

Jpn. Pat. Appln. KOKAI Publication No. 2001-54066 discloses a personal computer having a function of decoding motion video data that is stored on DVD (Digital Versatile Disc) media. In this computer, when motion video data is reproduced at a ½ reproduction speed of a normal reproduction speed, the operation speed of the decoder is set at ½ of the speed at the time of standard reproduction. Thereby, the motion video data is transferred from the decoder to the video memory at a frame rate (15 fps) of ½ of the frame rate (30 fps) at the time of standard reproduction.

Recent improvement in performance of a display controller, which is mounted in the personal computer as a graphics accelerator, is conspicuous. The state-of-the-art display controller includes a plurality of pipelines, and can execute at a very high frame rate a process of drawing frames in a video memory on the basis of a request for drawing from a processor (CPU).

However, the improvement in performance of the display controller leads to a major factor of an increase in total power consumption of the computer.

It is thus necessary to realize a novel function for reducing power consumption of the display controller, without adversely affecting the quality of display.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an example of the external appearance of a computer according to an embodiment of the invention;

FIG. 2 is an exemplary block diagram showing a system configuration of the computer shown in FIG. 1;

FIG. 3 is an exemplary block diagram showing an example of the structure of a display controller (GPU) which is provided in the computer shown in FIG. 1;

FIG. 4 shows an example of a memory map of a video memory which is provided in the computer shown in FIG. 1;

FIG. 5 shows an example of the functional structure of a display driver which is used in the computer shown in FIG. 1;

FIG. 6 shows an example of a setup screen which is used in the computer shown in FIG. 1; and

FIG. 7 is an exemplary flow chart illustrating an example of the procedure of a power-saving control process which is executed by the computer shown in FIG. 1.

### DETAILED DESCRIPTION

Various embodiments according to the invention will be described hereinafter with reference to the accompanying drawings. In general, according to one embodiment of the invention, an information processing apparatus includes: a processor; a display controller which executes a graphics arithmetic process of drawing frames in a video memory in accordance with a drawing request from the processor, and executes a screen refresh process of updating a display screen of a display device by using the frames drawn in the video memory in accordance with a refresh rate which designates a number of frames to be output to the display device per unit time; a calculation unit which calculates, based on content of the drawing request, a maximum number of frames which are drawable by the display controller per unit time; and a control unit which executes an operation speed control process of decreasing an operation speed of the display controller, if the calculated maximum number of frames is greater than the number of frames designated by the refresh rate.

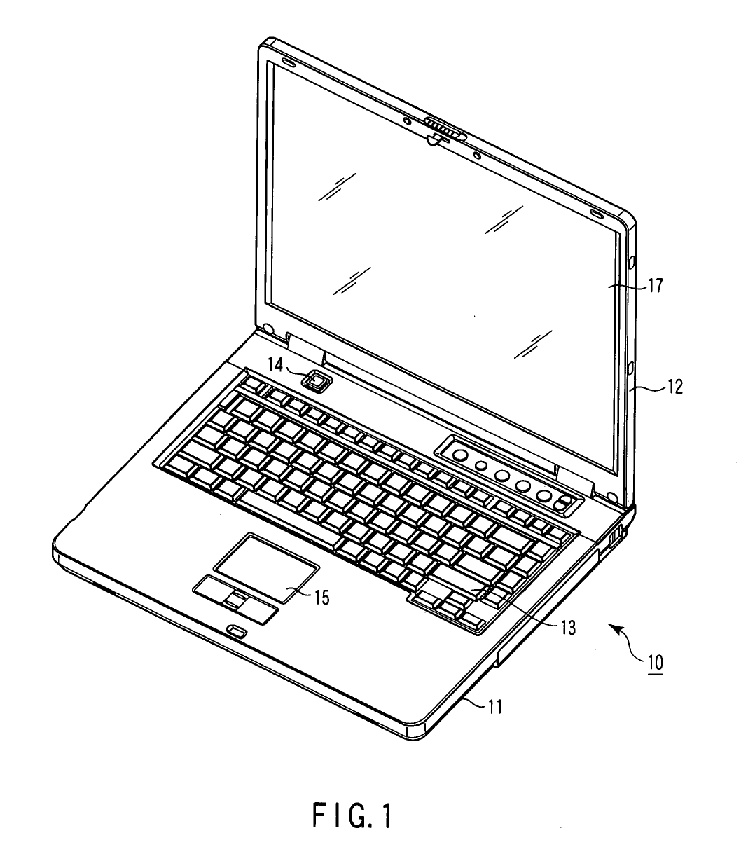

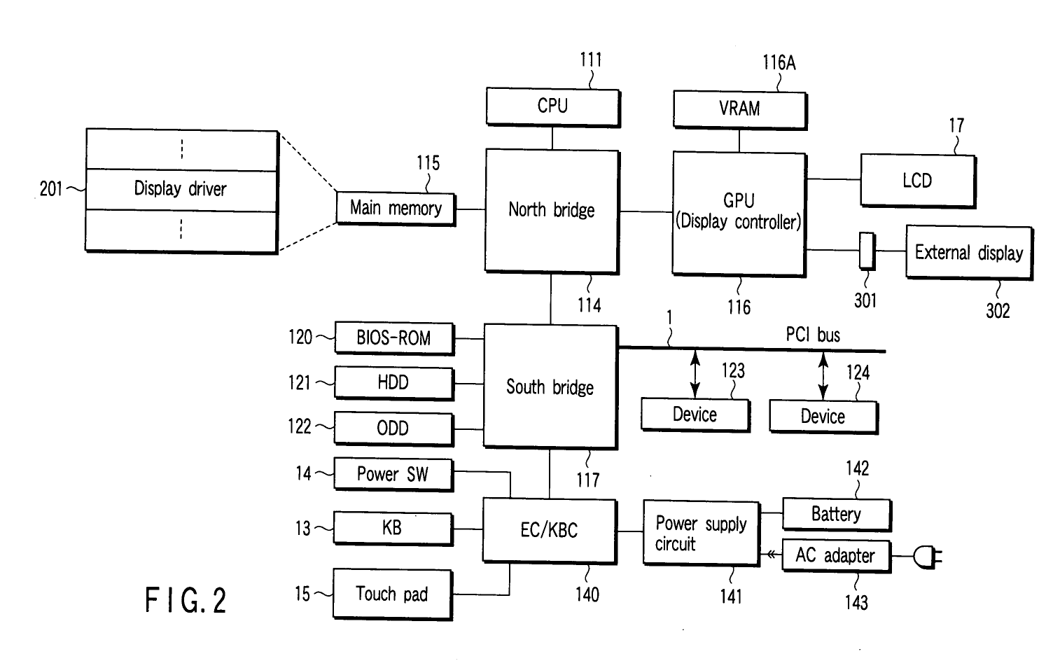

Referring to FIG. 1 and FIG. 2, the structure of an information processing apparatus according to the embodiment of the invention is described. The information processing apparatus is realized, for example, as a battery-powerable notebook-type portable personal computer 10.

FIG. 1 is a perspective view showing the computer 10 in the state in which a display unit thereof is opened. The computer 10 comprises a computer main body 11 and a display unit 12. A display device that is composed of an LCD (Liquid Crystal Display) 17 is built in the display unit 12. The display screen of the LCD 17 is positioned at an approximately central part of the display unit 12.

The display unit 12 is attached to the computer main body 11 such that the display unit 12 is freely rotatable between an open position and a closed position. The computer main body 11 has a thin box-shaped casing in which a battery can detachably be attached.

A keyboard 13, a power button switch 14 for powering on/off the computer 10 and a touch pad 15 are disposed on the top surface of the computer main body 11.

Next, referring to FIG. 2, the system configuration of the computer 10 is described.

The computer 10, as shown in FIG. 2, comprises a CPU 111, a north bridge 114, a main memory 115, a graphics processing unit (GPU) 116, a south bridge 117, a BIOS-ROM 120, a hard disk drive (HDD) 121, an optical disc drive (ODD) 122, various PCI (Peripheral Component Interconnect) devices 123, 124, an embedded controller/keyboard controller IC (EC/KBC) 140, and a power supply circuit 141.

The CPU 111 is a processor that is provided for controlling the operation of the computer 10. The CPU 111 executes an operating system and various application programs, which are loaded in the main memory 115 from the HDD 121. In addition, the CPU 111 executes a display driver 201 which is software for controlling the graphics processing unit (GPU) 116. A drawing request of 2D or 3D graphics, which is sent from the operating system or application program, is delivered to the graphics processing unit (GPU) 116 via the display driver 201. Further, the CPU 111 executes a system BIOS (Basic Input/Output System) that is stored in the BIOS-ROM 120. The system BIOS is a program for hardware control.

The north bridge 114 is a bridge device that connects a local bus of the CPU 111 and the south bridge 117. The north bridge 114 includes a memory controller that access-controls the main memory 115. The north bridge 114 has a function of executing communication with the graphics processing unit (GPU) 116 via, e.g. a PCI Express bus.

The graphics processing unit (GPU) 116 is a display controller for controlling the LCD 17 that is used as a display monitor of the computer 10, and an external display 302 such as a CRT. The external display 302 is connected, as needed, to an external video output terminal 301 which is provided on the computer main body 11.

The GPU 116 has a rendering function for displaying 2D graphics or 3D graphics on the display screen. The GPU 116 executes a graphics arithmetic process for drawing frames in a video memory (VRAM) 116A, on the basis of a drawing request which is sent from the CPU 111 via the north bridge 114. Specifically, if a drawing request corresponding to a certain frame is received, the GPU 116 executes various graphics arithmetic processes, which are designated by the received drawing request, generates a frame (display data) including various objects, and writes the generated frame (display data) to the video memory (VRAM) 116A.

In addition, the GPU 116 executes a screen refresh process for updating, in accordance with the value of a refresh rate, the display screen of the LCD 14 or external display 302 by using frames which are drawn in the video memory (VRAM) 116A. The refresh rate is a value indicative of the number of frames, which are to be output to the display device per unit time. The value of the refresh rate is basically 60 Hz, but it can be altered by the user on the setup screen.

The south bridge 117 is connected to a PCI bus 1 and executes communication with the PCI devices 123 and 124 via the PCI bus 1. The south bridge 117 includes an IDE (Integrated Drive Electronics) controller or a Serial ATA controller for controlling the hard disk drive (HDD) 121 and optical disc drive (ODD) 122.

The embedded controller/keyboard controller IC (EC/KBC) 140 is a 1-chip microcomputer in which an embedded controller for power management and a keyboard controller for controlling the keyboard (KB) 13 and touch pad 15 are integrated. The EC/KBC 140 has a function of powering on/off the computer 10 in response to the user's operation of the power button switch 14. The power on/off control of the computer 10 is executed by cooperation of the EC/KBC 140 and power supply circuit 141. The power supply circuit 141 uses power from a battery 142 which is mounted in the computer main body 11 or power from an AC adapter 143 which is connected to the computer main body 11 as the external power supply, thereby generating operational powers to the respective components.

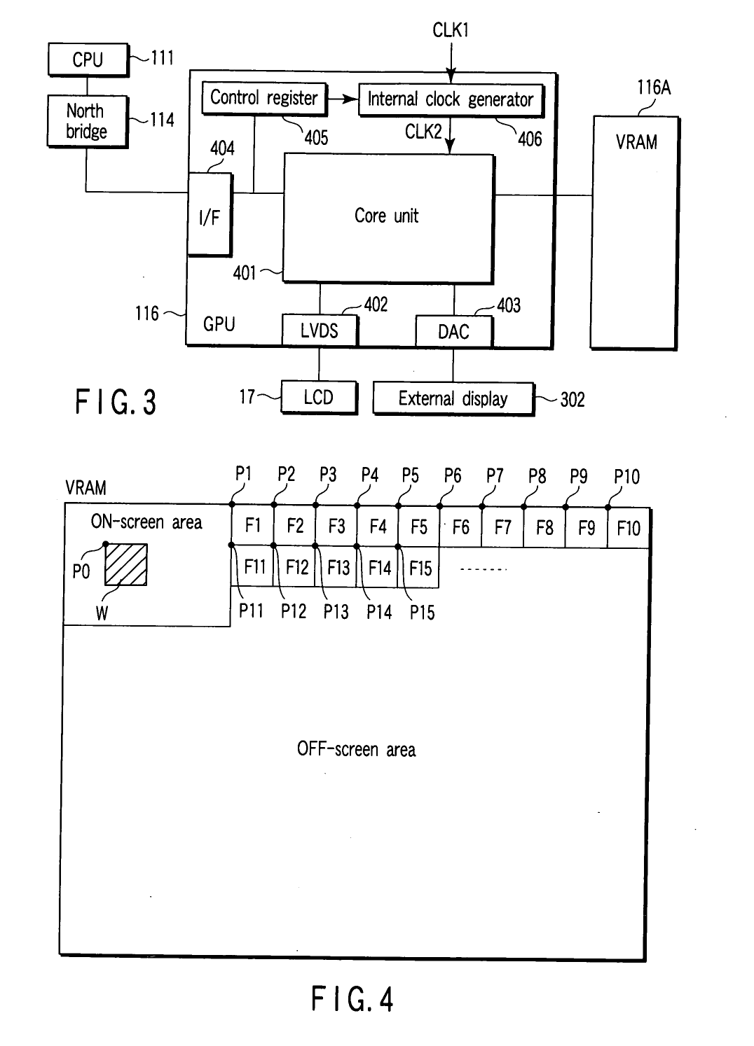

FIG. 3 shows an example of the structure of the GPU 116.

The GPU 116, as shown in FIG. 3, includes a core unit 401, an LVDS (Low Voltage Differential Signaling) interface unit 402, a D/A converter (DAC) 403, a host interface unit (I/F) 404, a control register 405, and an internal clock generator 406.

The core unit 401 is a unit which executes the above-described graphics arithmetic process and screen refresh process. The core unit 401 includes a 2D arithmetic process unit, a 3D arithmetic process unit, and a VRAM interface unit. The LVDS interface unit 402 converts display data, which is read out of the VRAM 116A by the core unit 401, to an LVDS-format display signal, and delivers the LVDS-format display signal to the LCD 17. The D/A converter (DAC) 403 converts display data to an analog-format display signal, and supplies the analog-format display signal to the external display 302.

The host interface unit (I/F) 404 receives a drawing request, object data such as a texture, and various control parameters relating to power management, which are sent from the CPU 111. The control parameters relating to power management includes a core clock parameter. The core clock parameter is a parameter for designating the frequency of an internal clock signal CLK2 which is supplied to the core unit 401 in the GPU 116. The core clock parameter is set in the control register 405. The internal clock generator 406 multiplies or divides the frequency of an external clock signal CLK1, thereby generating the internal clock signal CLK2 with the frequency designated by the core clock parameter. The internal clock generator 406 is composed of, e.g. a PLL (Phase Locked Loop) circuit.

The core unit 401 operates in sync with the internal clock signal CLK2. Thus, the operation speed of the core unit 401 varies in accordance with the frequency of the internal clock signal CLK2.

Next, referring to FIG. 4, the graphics arithmetic process, which is executed by the core unit 401 of the GPU 116 is described.

FIG. 4 shows an example of a memory map in the video memory in a case where 3D graphics are displayed on a window W which is positioned on the desktop screen.

An on-screen area and an off-screen area are mapped in the memory space in the video memory (VRAM) 116A. The on-screen area is an area which stores display data corresponding to the entire screen image that is to be displayed on the display screen. In a case where the window W is displayed on the display screen, a rectangular area of a size corresponding to the window W is disposed on the on-screen area. In this case, the values of all pixels of the display data in the rectangular area are set at zero.

Frames composed of 2D or 3D graphics, which are to be displayed in the window W on the display screen, are drawn on the off-screen area. Specifically, the core unit 401 of the GPU 116 executes the arithmetic process according to the drawing request from the CPU 111, thereby successively drawing frames F1, F2, . . . , which are composed of 2D or 3D graphics, on the off-screen area.

In the screen refresh process, the core unit 401 scans the on-screen area and reads out display data which is stored on the on-screen area. In this case, the value of a pointer, which indicates the coordinates of the upper left corner of the rectangular area is successively altered from frame to frame in the order of P0, P1, P2, P3, . . . . Thereby, in the screen refresh for the first frame, the content of the frame F1, which is drawn on the off-screen area, is read out of the off-screen area as display data that is to be displayed on the window W. In the screen refresh for the second frame, the content of the frame F2, which is drawn on the off-screen area, is read out of the off-screen area as display data that is to be displayed on the window W.

The speed of execution of the screen refresh process, which is carried out by the core unit 401, is determined by the refresh rate. For example, if the refresh rate is 60 Hz, 60 screen refresh processes are executed per second.

Thus, in the case where the refresh rate is 60 Hz, it should suffice if the frame rate of the drawing process, that is, the number of frames which are to be drawn on the off-screen area per second by the graphics arithmetic process, is basically 60 frames. This also applies to the case where the window W is displayed on the entire display screen.

The operation performance of the core unit 401 is sufficiently high. Thus, depending on the content of the drawing request from the CPU 111, even if the operation speed of the core unit 401 is decreased, the same number of frames as the number of frames designated by the refresh rate can be drawn in the video memory. Taking this into account, in the present embodiment, in order to reduce the power consumption of the GPU 116, the following power management function is executed by the display driver 201.

On the basis of the content of the drawing request that is sent from the CPU 111 to GPU 116, the display driver 201 calculates a maximum frame rate which is executable by the core unit 401, that is, a maximum number of frames which can be drawn by the core unit 401 per unit time. If the maximum number of frames is greater than the number of frames corresponding to the refresh rate, the display driver 201 executes an operation speed control process for decreasing the operation speed of the GPU 116.

This power management function can reduce the power consumption of the GPU 116 without causing deterioration in display quality.

FIG. 5 shows an example of the functional structure of the display driver 201.

A drawing request from the application program is sent to the display driver 201 via the operating system (OS). The display driver 201 sends the received drawing request to the GPU 116. The display driver 201 includes, as functional modules for executing the above-described power management function, a refresh rate acquisition unit 501, a frame rate calculation unit 502, and a GPU operation speed control unit 503. These refresh rate acquisition unit 501, frame rate calculation unit 502 and GPU operation speed control unit 503 are realized by software modules which are executed by the CPU 111.

The refresh rate acquisition unit 501 acquires a current set value of the refresh rate from the OS. The refresh rate acquisition unit 501 executes a process for informing the GPU 116 of the acquired value of the refresh rate.

The frame rate calculation unit 502 calculates a maximum frame rate which is executable by the GPU 116, that is, a maximum number of frames which can be drawn by the GPU 116 per unit time, on the basis of the content of the drawing request that is received via the operating system (OS). In this calculation process, for example, the amount of a predetermined graphics arithmetic operation to be executed, which is designated by the drawing request, is calculated. The calculated amount of the predetermined graphics arithmetic operation is, for example, the amount of a 3D vertex arithmetic operation to be executed. In accordance with the calculated amount of the graphics arithmetic operation, the maximum frame rate which is executable by the GPU 116, that is, the maximum number of frames which can be drawn by the GPU 116 per unit time, is determined.

If the maximum number of frames which can be drawn by the GPU 116 per unit time is greater than the number of frames designated by the refresh rate, the GPU operation speed control unit 503 executes an operation speed control process. This operation speed control process is a process for decreasing the operation speed of the GPU 116 on the basis of the relationship between the maximum number of frames which can be drawn by the GPU 116 per unit time and the number of frames designated by the refresh rate, so that the maximum number of frames which can be drawn by the GPU 116 per unit time may decrease to the number of frames designated by the refresh rate. In the operation speed control process, the GPU operation speed control unit 503 executes a process for controlling the frequency of the internal clock signal CLK2 by sending the core clock parameter to the GPU 116. Needless to say, the frequency of the external clock signal CLK1 may be controlled. The operation speed of the GPU 116 can also be decreased by controlling the frequency of a memory clock signal that is supplied to the VRAM 116A. Further, the operation speed of the GPU 116 can be decreased by varying the value of power supply voltage that is supplied to the GPU 116.

By the above-described operation speed control process, the frame rate of drawing that is executed by the GPU 116 can automatically be synchronized with the refresh rate.

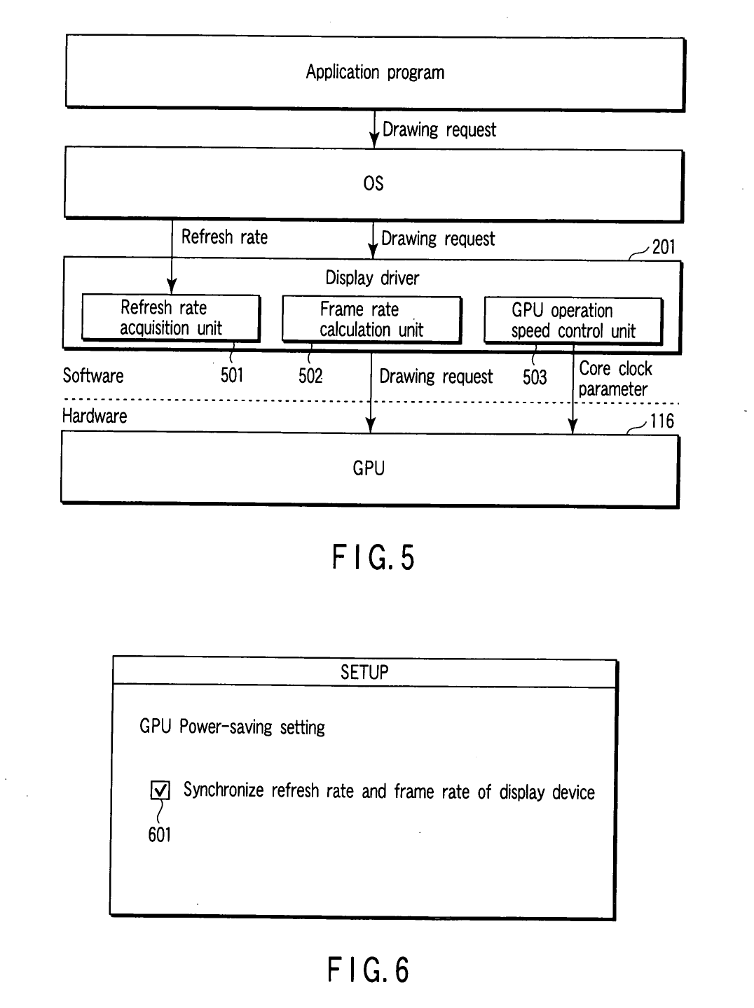

FIG. 6 shows an example of a setup screen relating to the power management of the GPU 116. This setup screen is a setup screen for prompting the user to select one of a first mode (power-saving mode) which permits execution of the operation speed control process and a second mode which prohibits execution of the operation speed control process. The setup screen is displayed on the display device by the display driver 201. If a check box 601 on the setup screen is checked by the user, the execution of the operation speed control process is permitted (power-saving mode). In the power-saving mode, the frame rate of drawing is automatically synchronized with the refresh rate. On the other hand, if the check box 601 is not checked by the user, the operation speed control process is not executed. For example, when a performance test of the GPU 116 is performed, the execution of the operation speed control process is prohibited and thereby the performance of the GPU 116 can correctly be determined.

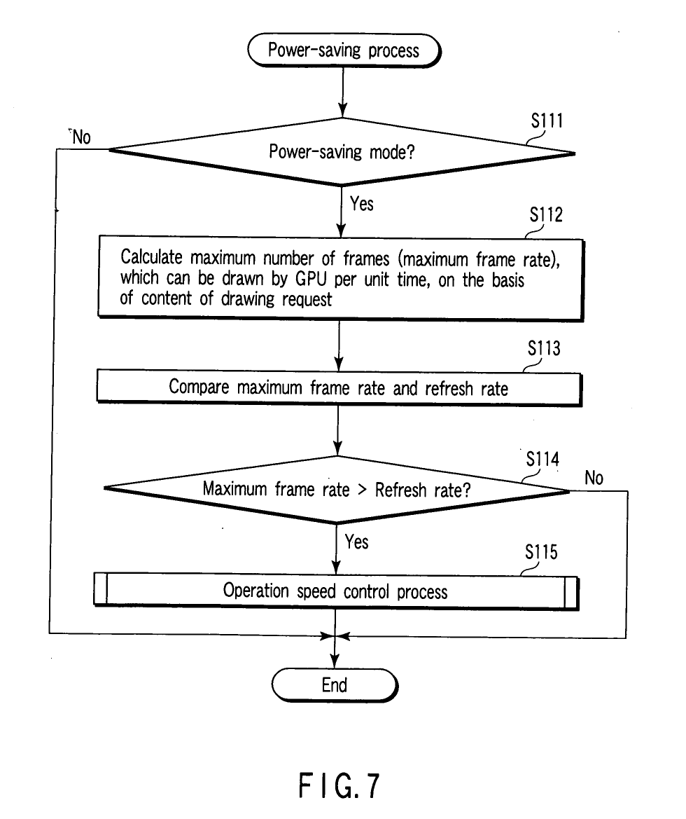

Next, referring to a flow chart of FIG. 7, a description is given of the procedure of a power-saving process for controlling the operation of the GPU 116.

At the time of the initializing process of the GPU 116, the frequency of the internal clock signal CLK2 of the GPU 116 is set at a maximum frequency. Thereby, the GPU 116 can operate with 100% performance.

The display driver 201 first determines whether the power-saving mode is effective or not, that is, whether the execution of the operation speed control process is permitted or not (block 111).

If the power-saving mode is effective (YES in block S111), the display driver 201 calculates the maximum number of frames (maximum frame rate) which can be drawn per second in the case where the GPU 116 operates with 100% performance, on the basis of the content of the drawing request that is sent from the CPU 111 to the GPU 116, for example, the amount of arithmetic processing such as 3D vertex arithmetic processing (block S112). The calculation of the maximum frame rate is executed, for example, in units of one frame, or in units of some consecutive frames. For example, in the case where the amount of arithmetic processing, which is designated by the drawing request, varies from frame to frame, the calculated value of the maximum frame rate varies from frame to frame.

Subsequently, the display driver 201 compares the calculated maximum frame rate and the current refresh rate of the display device (block S114). If the calculated maximum frame rate is greater than the number of frames to be updated per second, which is designated by the refresh rate (YES in block S114), the display driver 201 executes the operation speed control process for decreasing the operation speed of the GPU 116 to decrease the number of frames which are drawn by the GPU 116 per unit time to the number of frames designated by the refresh rate (block S115). In block S115, the display driver 201 decreases the operation speed of the GPU 116 on the basis of the relationship between the calculated maximum frame rate and the number of frames designated by the refresh rate, so that the number of frames, which are drawable by the GPU 116 per second, may agree with the number of frames designated by the refresh rate. For example, if the calculated maximum frame rate is 120 fps and the number of frames designated by the refresh rate is 60 fps, the display driver 201 sets the operation speed of the GPU 116 at ½ of the maximum operation speed. In this case, the display driver 201 may send the core clock parameter to the GPU 116, thereby setting the frequency of the internal clock signal CLK2 at ½ of the maximum frequency.

Even if drawing is performed at a frame rate higher than a refresh rate, such drawing cannot be sensed by the human eye and has no meaning except for a performance test of the GPU 116. In this embodiment, the operation speed of the GPU 116 can be optimized by executing the above-described operation speed control process, and the power consumption of the GPU 116 can be reduced without adversely affecting the quality of display.

By the above-described operation speed control process, the operation speed of the GPU 116 can adaptively be varied in units of, e.g. a frame, in accordance with the content of the drawing request. As regards a frame with respect to which the amount of arithmetic processing designated by the drawing request is relatively large, the amount of decrease in operation speed of the GPU 116 is small. However, as regards a frame with respect to which the amount of arithmetic processing designated by the drawing request is relatively small, the operation speed of the GPU 116 is greatly decreased.

The refresh rate acquisition unit 501, frame rate calculation unit 502 and GPU operation speed control unit 503, which have been described with reference to FIG. 5, can also be realized by dedicated hardware. This hardware may be provided within the GPU 116.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a processor;
a display controller which executes a graphics arithmetic process of drawing frames in a video memory in accordance with a drawing request from the processor, and executes a screen refresh process of updating a display screen of a display device by using the frames drawn in the video memory in accordance with a refresh rate which designates a number of frames to be output to the display device per unit time;
a calculation unit which calculates, based on content of the drawing request, a maximum number of frames which are drawable by the display controller per unit time; and
a control unit which executes an operation speed control process of decreasing an operation speed of the display controller, if the calculated maximum number of frames is greater than the number of frames designated by the refresh rate.

2. The information processing apparatus according to claim 1, wherein the control unit is configured to decrease the operation speed of the display controller based on a relationship between the calculated maximum number of frames and the number of frames designated by the refresh rate, thereby to decrease the number of frames which are drawn by the display controller per unit time to the number of frames designated by the refresh rate.

3. The information processing apparatus according to claim 1, wherein the control unit is configured to decrease the operation speed of the display controller by controlling a frequency of an external clock signal which is supplied to the display controller or a frequency of an internal clock signal which is supplied to a core unit in the display controller.

4. The information processing apparatus according to claim 1, wherein the calculation unit calculates an amount of a given graphics arithmetic operation, which is designated by the drawing request, and calculates the maximum number of frames based on the calculated amount of the graphics arithmetic operation.

5. The information processing apparatus according to claim 1, further comprising means for displaying a setup screen for prompting a user to select one of a first mode which permits execution of the operation speed control process and a second mode which prohibits execution of the operation speed control process,
wherein the control unit executes the operation speed control process if the first mode is selected on the setup screen and the calculated maximum number of frames is greater than the number of frames designated by the refresh rate.

6. An information processing apparatus comprising:
a processor;
a display device;
a display controller which executes a graphics arithmetic process of drawing frames in a video memory in accordance with a drawing request from the processor, and executes a graphics arithmetic process of drawing frames in a video memory and a screen refresh process of updating a display screen of the display device by using the frames drawn in the video memory in accordance with a refresh rate which designates a number of frames to be output to the display device per unit time; and
an operation speed control unit which calculates, based on an amount of a given graphics arithmetic operation which is designated by the drawing request, a maximum number of frames which are drawable by the display controller per unit time, and executes an operation speed control process of decreasing an operation speed of the display controller, if the calculated maximum number of frames is greater than the number of frames designated by the refresh rate, thereby to decrease the number of frames which are drawn by the display controller per unit time to the number of frames designated by the refresh rate.

7. The information processing apparatus according to claim 6, wherein the operation speed control unit decreases the operation speed of the display controller by controlling a frequency of an external clock signal which is supplied to the display controller or a frequency of an internal clock signal which is supplied to a core unit in the display controller.

8. The information processing apparatus according to claim 6, further comprising means for displaying a setup screen for prompting a user to select one of a first mode which permits execution of the operation speed control process and a second mode which prohibits execution of the operation speed control process,
wherein the operation speed control unit executes the operation speed control process if the first mode is selected on the setup screen and the calculated maximum number of frames is greater than the number of frames designated by the refresh rate.

9. A method of controlling an operation speed of a display controller which is provided in an information processing apparatus, the display controller being configured to execute a graphics arithmetic process of drawing frames in a video memory in accordance with a drawing request which is sent from a processor provided in the information processing apparatus, and to execute a screen refresh process of updating a display screen of a display device by using the frames drawn in the video memory in accordance with a refresh rate which designates a number of frames to be output to the display device per unit time, the method comprising:
calculating, based on content of the drawing request, a maximum number of frames which are drawable by the display controller per unit time; and
executing an operation speed control process of decreasing the operation speed of the display controller, in a case where the calculated maximum number of frames is greater than the number of frames designated by the refresh rate.

10. The method according to claim 9, wherein said executing the operation speed control process includes decreasing the operation speed of the display controller based on a relationship between the calculated maximum number of frames and the number of frames designated by the refresh rate, thereby to decrease the number of frames which are drawn by the display controller per unit time to the number of frames designated by the refresh rate.

11. The method according to claim 9, wherein said executing the operation speed control process includes controlling a frequency of an external clock signal which is supplied to the display controller or a frequency of an internal clock signal which is supplied to a core unit in the display controller, thereby to decrease the operation speed of the display controller.

12. The method according to claim 9, wherein said calculating the maximum number of frames includes calculating an amount of a predetermined graphics arithmetic operation, which is designated by the drawing request, and calculating the maximum number of frames based on the calculated amount of the graphics arithmetic operation.

13. The method according to claim 9, further comprising displaying a setup screen for prompting a user to select one of a first mode which permits execution of the operation speed control process and a second mode which prohibits execution of the operation speed control process,
wherein the operation speed control process is executed if the first mode is selected on the setup screen and the calculated maximum number of frames is greater than the number of frames designated by the refresh rate.
